(19) United States
(12) Patent Application Publication
(10) Pub. No.: US 2010/0311360 A1
(43) Pub. Date: Dec. 9, 2010

(54) TRANSMITTER, METHOD FOR LOWERING SIGNAL DISTORTION, AND METHOD FOR GENERATING PREDISTORTION PARAMETERS UTILIZED TO LOWER SIGNAL DISTORTION

(76) Inventors: Fong-Ching Huang, Hsin-Chu City (TW); Yuan-Shuo Chang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/795,642

(22) Filed: Jun. 7, 2010

Related U.S. Application Data
(60) Provisional application No. 61/184,842, filed on Jun. 8, 2009.

(51) Int. Cl. H04B 1/04

(52) U.S. Cl. 455/114.3

(57) ABSTRACT

A transmitter includes a predistortion calculation unit, a transmitting circuit, a receiving circuit, an adjusting unit and a parameter generating and storing unit. The predistortion calculation unit is utilized for pre-distorting an input signal to generate a predistorted input signal according to a specific predistortion parameter. The transmitting circuit is utilized for processing the predistorted input signal to generate an output signal. The receiving circuit is utilized for receiving the output signal to generate a received signal. The adjusting unit is utilized for adjusting the received signal to generate an adjusted signal, where the adjusted signal is substantially equal to the input signal. The parameter generating and storing unit is utilized for generating the specific predistortion parameter, and updating at least one stored predistortion parameter according to the input signal and the adjusted signal.

### CROSS REFERENCE TO RELATED APPLICATIONS

This application claims the priority of U.S. Provisional Application No. 61/184,842, filed Jun. 8, 2009, which is included herein by reference in its entirety.

### BACKGROUND OF THE INVENTION

1. Field of the Invention

The present invention relates to a transmitter, and more particularly, to a transmitter which can lower the signal distortion and related method.

2. Description of the Prior Art

In a wireless communication system, a transmitter has a power amplifier to amplify a signal which is to be delivered. To obtain a good quality of the amplified signal, the power amplifier has to offer a good linearity. Therefore, a predistortion circuit is positioned before the power amplifier to pre-compensate a non-linear effect of the power amplifier. Please refer to FIG. 1. FIG. 1 is a diagram showing characteristic curves of a predistortion circuit 110 and a power amplifier 120. As shown in FIG. 1, the linearity between an input signal V₁ and an output V₃ of the overall circuit (including the predistortion circuit 110 and the power amplifier 120) is better, and the correctness of the output signal V₃ can be improved.

In addition, U.S. Pat. No. 6,741,663 discloses a predistortion circuit which can compensate the non-linear issue of the power amplifier. However, it needs complicated algorithms and higher cost. Therefore, how to provide a simple and efficient predistortion circuit becomes an important issue.

### SUMMARY OF THE INVENTION

It is therefore an objective of the present invention to provide a transmitter which can lower signal distortion and related method, to solve the above-mentioned problems.

According to one embodiment of the present invention, a transmitter comprises a parameter generating and storing unit, a predistortion calculation unit and a transmitting circuit, where the parameter generating and storing unit comprises a storage unit, an address generating unit and an interpolation unit. The storage unit is utilized for storing a plurality of predistortion parameters. The address generating unit is utilized for generating an address signal according to a power of an input signal, where the address signal includes a first portion and a second portion, and the address generating unit is further utilized for obtaining a first predistortion parameter and a second predistortion parameter from the storage unit according to the first portion of the address signal. The interpolation unit is utilized for performing an interpolation operation upon the first and the second predistortion parameters according to the second portion of the address signal to generate a specific predistortion parameter. The predistortion calculation unit is utilized for pre-distorting the input signal to generate a predistorted input signal according to the specific predistortion parameter. The transmitting circuit is utilized for processing the predistorted input signal to generate an output signal.

According to another embodiment of the present invention, a method for lowering signal distortion comprises: providing a storage unit to store a plurality of predistortion parameters; determining an address signal according to a power of an input signal, where the address signal includes a first portion and a second portion; obtaining a first predistortion parameter and a second predistortion parameter from the storage unit according to the first portion of the address signal; performing an interpolation operation upon the first and the second predistortion parameters according to the second portion of the address signal to generate a specific predistortion parameter; pre-distorting the input signal to generate a predistorted input signal; and processing the predistorted input signal to generate an output signal.

According to another embodiment of the present invention, a transmitter comprises a predistortion calculation unit, a transmitting circuit, a receiving circuit, an adjusting unit and a parameter generating and storing unit. The predistortion calculation unit is utilized for pre-distorting an input signal to generate a predistorted input signal according to a specific predistortion parameter. The transmitting circuit is utilized for processing the predistorted input signal to generate an output signal. The receiving circuit is utilized for receiving the output signal to generate a received signal. The adjusting unit is utilized for adjusting the received signal to generate an adjusted signal, where the adjusted signal is substantially equal to the input signal. The parameter generating and storing unit is utilized for generating the specific predistortion parameter, and updating at least one stored predistortion parameter according to the input signal and the adjusted signal.

According to another embodiment of the present invention, a method for generating a plurality of predistortion parameters utilized for lowering signal distortion comprises: pre-distorting an input signal to generate a predistorted input signal according to a specific predistortion parameter; processing the predistorted input signal to generate an output signal; receiving the output signal to generate a received signal; adjusting the received signal to generate an adjusted signal; and updating at least a predistortion parameter stored in a storage unit according to the input signal and the adjusted signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing characteristic curves of a predistortion circuit and a power amplifier.

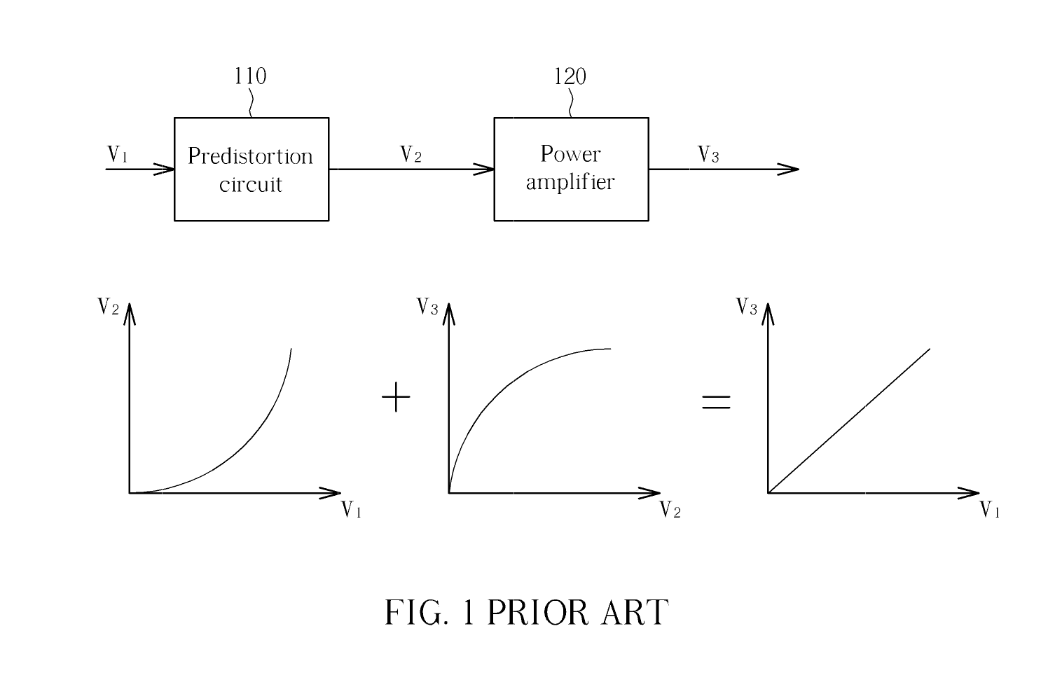

FIG. 2 is a diagram illustrating a transmitter according to one embodiment of the present invention.

FIG. 3 is a diagram illustrating the address generating unit and the memory shown in FIG. 2.

FIG. 4 is a flowchart of lowering signal distortion according to one embodiment of the present invention.

FIG. 5 is a flowchart of generating a plurality of predistortion parameters stored in the look-up table according to one embodiment of the present invention.

FIG. 6 is a diagram showing the adaptation unit generating the adjusting parameter W.

FIG. 7 is a diagram showing the adaptation unit updating the predistortion parameters.

### DETAILED DESCRIPTION

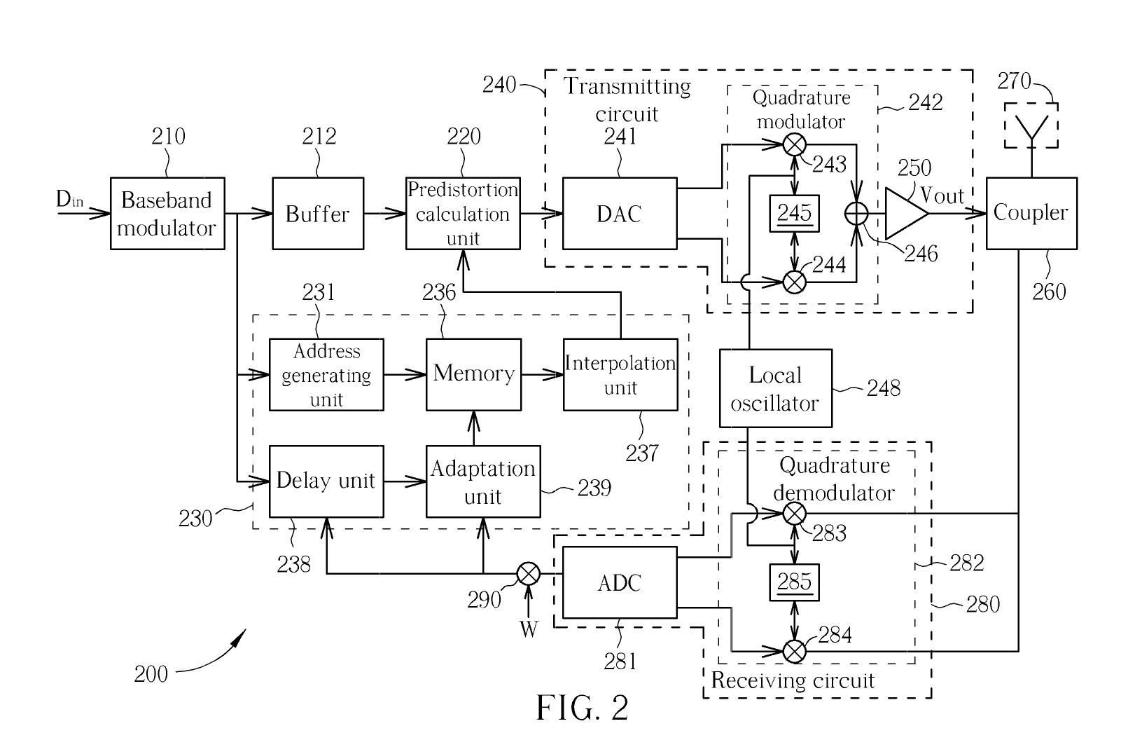

Please refer to FIG. 2. FIG. 2 is a diagram illustrating a transmitter 200 according to one embodiment of the present invention. As shown in FIG. 2, the transmitter 200 comprises a baseband modulator 210, a buffer 212, a predistortion calculation unit 220, a parameter generating and storing unit 230, a transmitting circuit 240, a local oscillator 248, a coupler 260, an antenna 270, a receiving circuit 280, and an adjusting unit (in this embodiment, a complex multiplier 290 serves as the adjusting unit). The parameter generating and storing unit 230 comprises an address generating unit 231, a storage unit (in this embodiment, a memory 236 serves as the storage unit), an interpolation unit 237, a delay unit 238 (in this embodiment, the delay unit 238 can be a programmable delay unit), and an adaptation unit 239; the transmitting circuit 240 comprises a digital to analog converter (DAC) 241, a quadrature modulator 242 and an power amplifier 250, where the quadrature modulator 242 includes two multipliers 243 and 244, a 90-degree phase shifter 245 and an adder 246; the receiving circuit 280 includes an analog to digital converter (ADC) 281 and a quadrature demodulator 282, where the quadrature demodulator 282 includes two multipliers 283 and 284 and a 90-degree phase shifter 285.

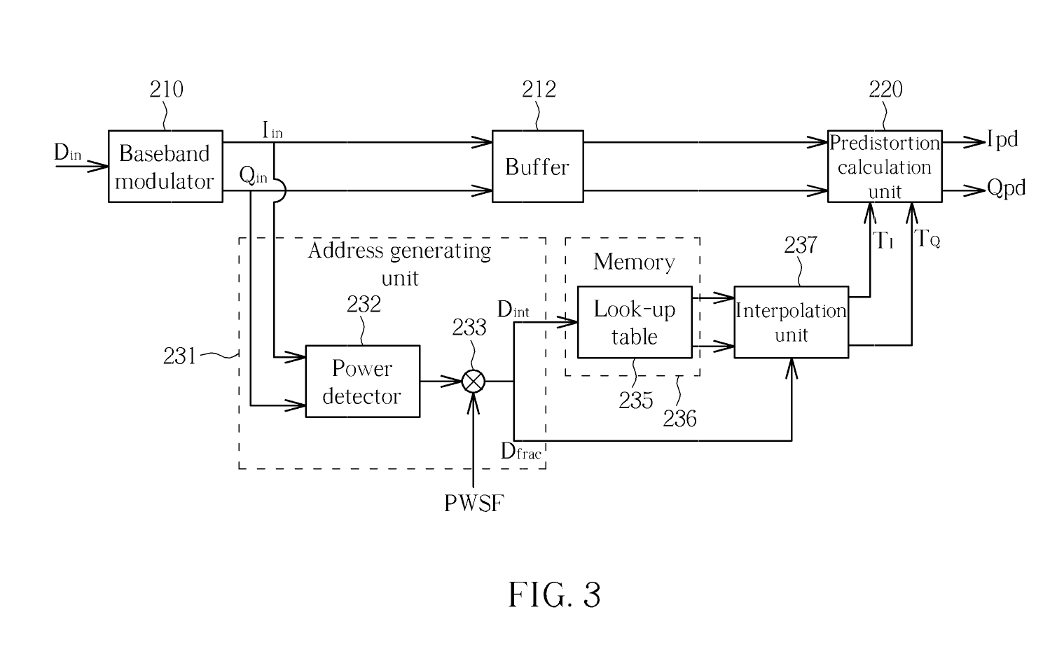

Please refer to FIG. 3. FIG. 3 is a diagram illustrating the address generating unit 231 and the memory 236. The address generating unit 231 includes a power detecting unit 232 and a multiplier 233. The memory 236 includes a look-up table 235 storing a plurality of predistortion parameters which correspond to a plurality of amplitudes of an input signal, respectively.

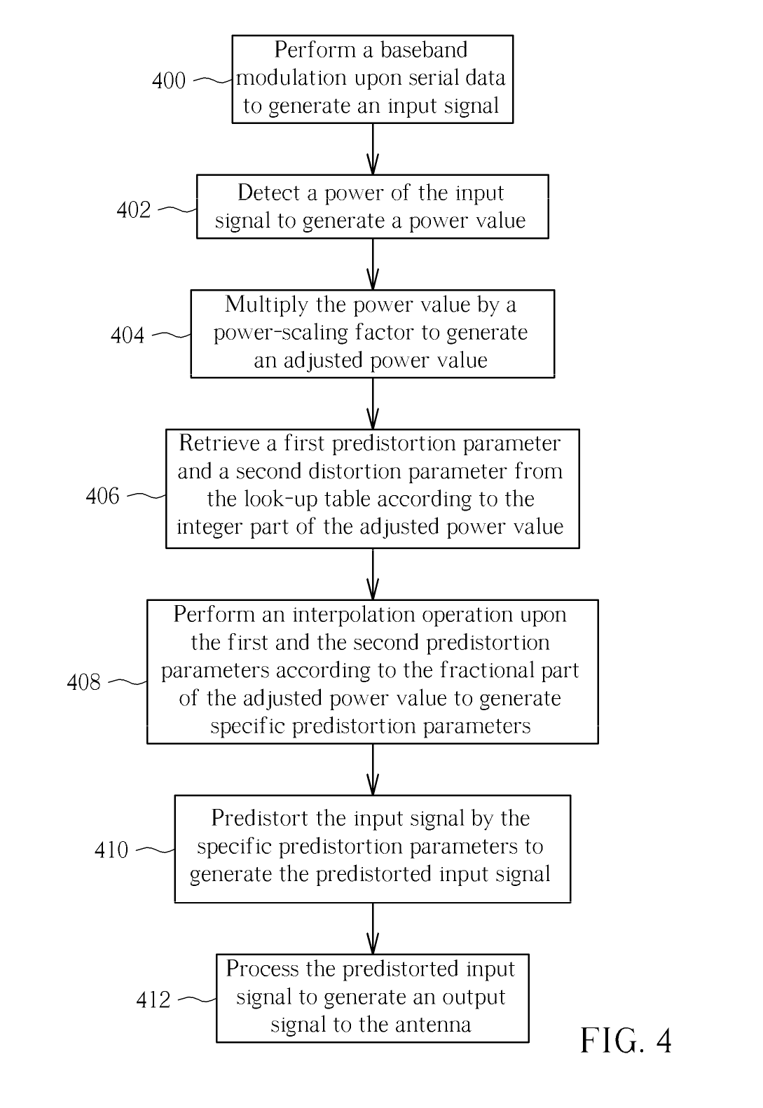

Please refer to FIGS. 2-4 together. FIG. 4 is a flowchart of lowering signal distortion according to one embodiment of the present invention. Referring to FIGS. 2-4, the flow is described as follows:

In Step 400, the baseband modulator 210 performs a baseband modulation upon serial data Dᵢₙ to generate an input signal including an in-phase signal Iᵢₙ and a quadrature signal Qᵢₙ. Then, in Step 402, the power detector 232 detects a power of the input signal to generate a power value. For example, the power detector 232 can generate the power value by a formula (|Iᵢₙ|²+|Qᵢₙ|²) or any other method which can generate a value representing the power value of the input signal. In Step 404, the multiplier 233 multiplies the power value generated from the power detector 232 by a power-scaling factor PWSF to generate an adjusted power value. For example, assuming that Iᵢₙ=0.5, Qᵢₙ=0.4, PWSF=64, then the power value generated from the power detector 232 is 0.41, and the adjusted power value is 0.41*64=26.24. In addition, an integer part and a fractional part of the adjusted power value (26.24) can be represented by five-bit binary codes, respectively, that is the integer part is b′11010 and the fractional part is b′11000. Therefore, the adjusted power value can be served as an address signal. Then, in Step 406, the address generating unit 231 retrieves a first predistortion parameter and a second distortion parameter from the look-up table 235 according to the integer part Dint of the address signal (i.e., the adjusted power value). In Step 408, the interpolation unit 237 performs an interpolation operation upon the first and the second predistortion parameters according to the fractional part of the address signal to generate specific predistortion parameters T_{I} and T_{Q}. As previously mentioned, the more accurate predistortion parameter (i.e., specific predistortion parameters T_{I} and T_{Q}) is provided and the size of the memory 236 is not necessary to be increased. Taking an example to describe the Steps 406 and 408, assuming that the adjusted power value is 26.24 and the integer part and the fractional part of the address signal are b′11010 and b′11000, respectively, then the address generating unit 231 retrieves the first predistortion parameter X_{I} and the second predistortion parameter Y_{I} from the look-up table 235, where the first predistortion parameter X_{I} corresponds to a value “26” and the second predistortion parameter Y_{I} corresponds to a value “27”. Then the interpolation unit 237 calculates the specific predistortion parameter T_{I} according to the formula T_{I}=λX_{I}+(1−λ)Y_{I}, where λ=(24/32). In addition, the specific predistortion parameter T_{Q} is calculated by a similar method.

It is noted that, the power-scaling factor PWSF is used to adjust a scale of the power of the input signal, and the power-scaling factor PWSF is proportional to a gain of the power amplifier 250. Because the gain and the input of the power amplifier 250 will vary due to a gain variation of a front-end circuit, the predistortion parameter retrieved from the look-up table 235 may be not a required predistortion parameter if the power is not scaled by the power-scaling factor PWSF. Therefore, the embodiment uses the power-scaling factor PWSF to dynamically adjust the power of the input signal to make sure the predistortion parameter retrieved from the look-up table 235 is correct.

Then, in Step 410, the predistortion calculating unit 220 performs a predistortion operation upon the in-phase signal Iᵢₙ and the quadrature signal Qᵢₙ by the specific predistortion parameters T_{I} and T_{Q} to generate the predistorted input signal including I_{pd} and Q_{pd}. Then, in Step 412, the digital to analog converter 241, the quadrature modulator 242 and the power amplifier 250 process the predistorted input signal including I_{pd} and Q_{pd} to generate an output signal Vₒᵤₜ to the coupler 260, and the antenna 270 delivers the output signal Vₒᵤₜ. Please note that, a person skilled in this art should understand the operations of the digital to analog converter 241, the quadrature modulator 242 and the power amplifier 250, further descriptions are therefore omitted here.

In addition, before the transmitter 200 starts to be normally worked, the transmitter 200 needs to generate a plurality of predistortion parameters and stores the plurality of predistortion parameters into the look-up table 235. The flow of generating the predistortion parameters stored in the look-up table 235 is described as follows.

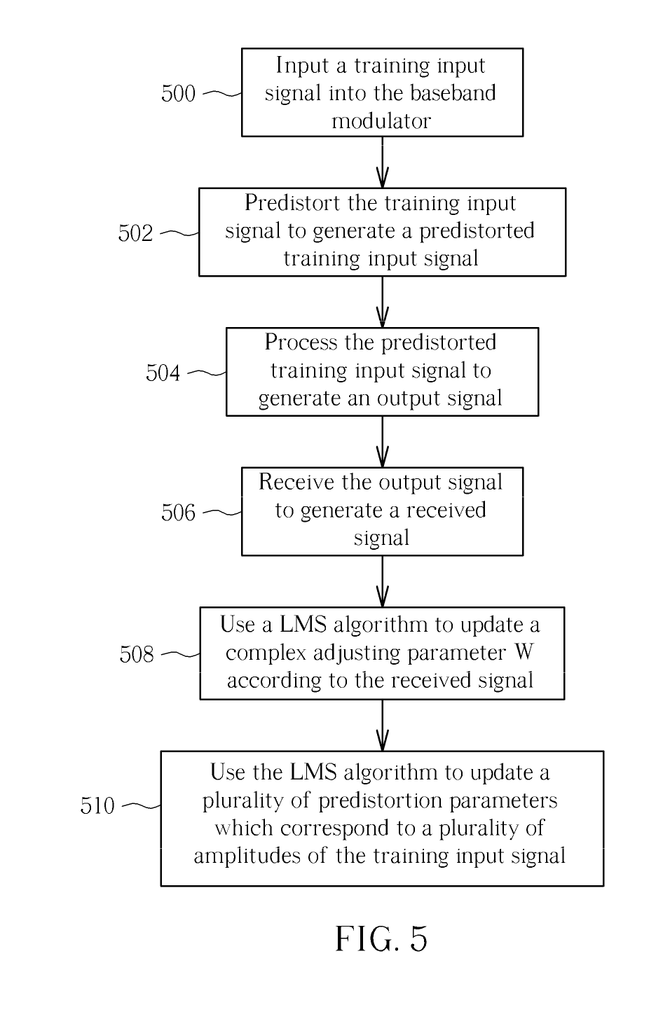

Please refer to FIG. 2 and FIG. 5. FIG. 5 is a flowchart of generating a plurality of predistortion parameters stored in the look-up table 235 according to one embodiment of the present invention. Referring to FIG. 5, the flow is described as follows:

In Step 500, a training input signal is inputted into the baseband modulator 210, where the training input signal is a down ramp signal (i.e., an amplitude of the training input signal is gradually decreased). Using the down ramp training input signal can lower the design cost of the transmitter 200 because only the first sine wave of the training input signal needs to be detected if exceeding a range of the digital to analog converter 241. Then, in Step 502, the training input signal is buffered by the buffer 212 and the predistortion calculation unit 220 processes the buffered training input signal to generate a predistorted training input signal (It is noted that, when the predistortion calculation unit 220 processes the first sine wave of the training input signal, the predistortion calculation unit 220 can bypass the first sine wave or process the first sine wave by a default predistortion parameter whose value is equal to 1). In Step 504, the transmitting circuit 240 processes the predistorted training input signal to generate an output signal Vₒᵤₜ. Then, in Step 506, the receiving circuit 280 receives the output signal Vₒᵤₜ via the coupler 260 to generate a received signal. In Step 508, the adaptation unit 239 updates a complex adjusting parameter W according to the received signal and a LMS (Least Mean Square) algorithm, where the complex adjusting parameter W is used for compensating a signal distortion caused by the transmitting circuit 240, the coupler 260 and the receiving circuit 280. That is an adjusted signal outputted from the multiplier 290 will be substantially equal to the input signal inputted into the buffer 212.

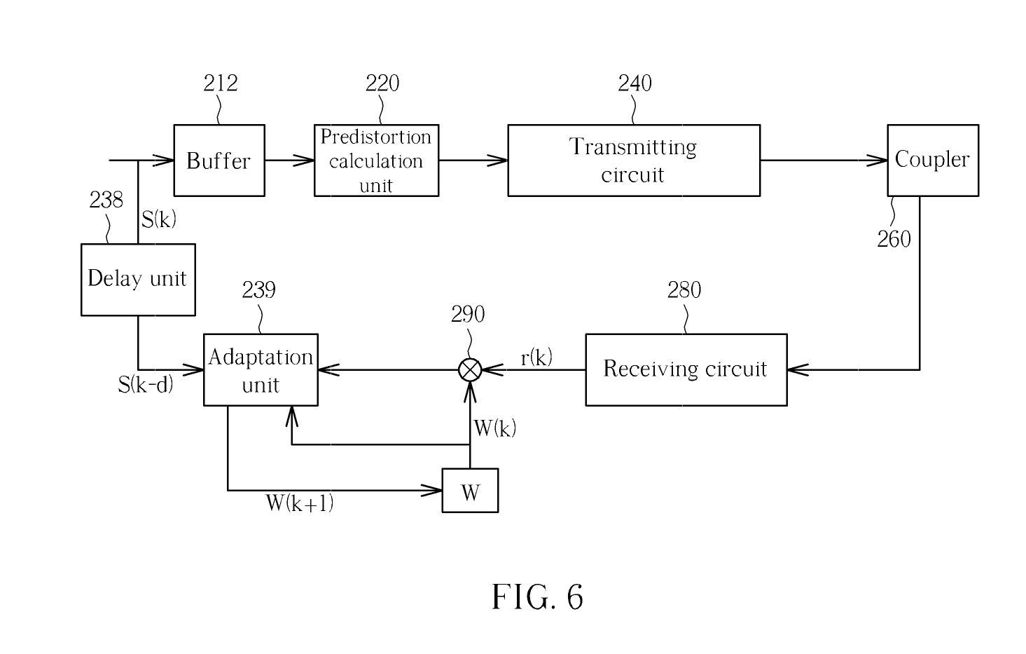

Please refer to FIG. 6 to describe the operations of the adaptation unit 239 in detail. Assuming that the current timing is k and the programmable delay unit 238 delays the input signal S(k) by a timing d to make the signal S(k−d) and the signal r(k)*W(k) entered into the adaptation unit 239 be synchronized (i.e., the timing d is a timing delay due to the buffer 212, the predistortion calculation unit 220, the transmitting circuit 240, the coupler 260 and the receiving circuit 280), then the adaptation unit 239 compares the signal S(k−d) outputted from the programmable delay unit 238 and the signal r(k)*W(k) outputted from the multiplier 290 to generate an error signal e(k), where e(k)=S(k−d)−r(k)*W(k). Then, the complex adjusting parameter W is updated according to the formula W(k+1)=W(k)+μe(k)conj(r(k)), where μ is a complex step size, and the complex step size μ is determined by the following condition:

$$abs ( μ ) < \frac{\sqrt{2}}{abs ( r )} ,$$

and abs( ) is an absolute-value operator and conj( ) is an operator of complex conjugate. The above-mentioned LMS algorithm is used to update the complex adjusting parameter W until the error signal e(k) is less than a predetermined value (i.e., S(k−d) is close to or equal to r(k)*W(k)), and the latest complex adjusting parameter is determined and is for compensating signal distortion of the transmitting circuit 240, the coupler 260 and the receiving circuit 280.

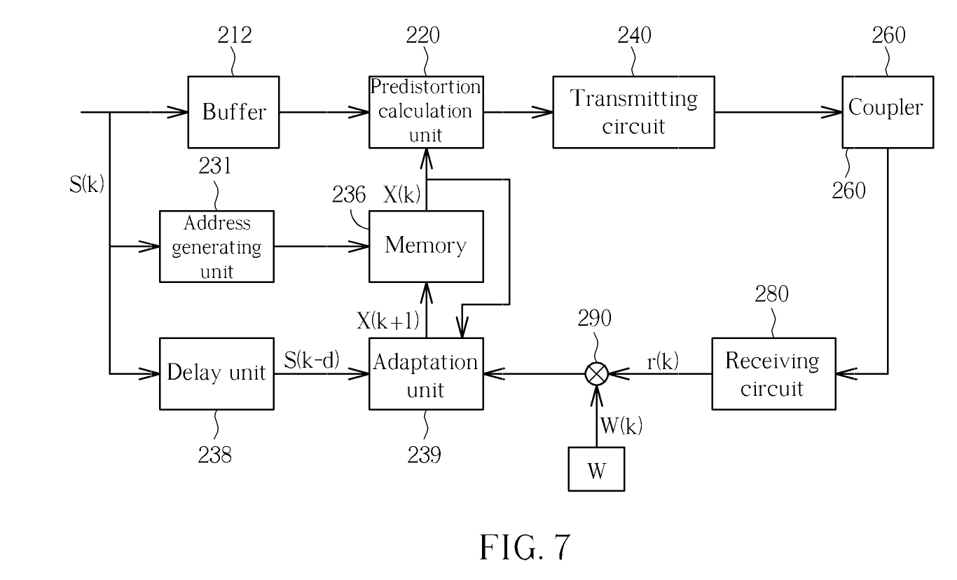

After the complex adjusting parameter W is determined, in Step 510, the adaptation unit 239 of the parameter generating and storing unit 230 uses the LMS algorithm to update a plurality of predistortion parameters which correspond to a plurality of amplitudes of the training input signal. Please refer to FIG. 7 to describe the operations of the adaptation unit 239 in detail. Assuming that the current timing is k and the programmable delay unit 238 delays the input signal S(k) by a timing d to make the signal S(k−d) and the signal r(k)*W(k) entered into the adaptation unit 239 be synchronized (i.e., the timing d is a timing delay due to the buffer 212, the predistortion calculation unit 220, the transmitting circuit 240, the coupler 260 and the receiving circuit 280), then the adaptation unit 239 compares the signal S(k−d) outputted from the programmable delay unit 238 and the signal r(k)*W(k) outputted from the multiplier 290 to generate an error signal e(k), where e(k)=S(k−d)−r(k)*W(k). Then, one of the predistortion parameter Xᵢ is updated according to the formula Xᵢ(k+1)=Xᵢ(k)+μe(k)conj(S(k−d)), where μ is a complex step size, and the complex step size μ is determined by the following condition:

$$abs ( μ ) < \frac{\sqrt{2}}{abs ( r )} ,$$

and abs( ) is an absolute-value operator and conj( ) is an operator of complex conjugate. In addition, using the complex step size μ can increase the convergence speed. The above-mentioned LMS algorithm is used to update the predistortion parameter, and the updated Xᵢ(k+1) is stored into the memory 236.

Referring to the above-mentioned Steps 508 and 510, because the complex adjusting parameter W which can compensate signal distortion of the transmitting circuit 240, the coupler 260 and the receiving circuit 280 is determined before the adaptation unit 239 generates the predistortion parameters, the generation of the predistortion parameters will be faster, increasing the system efficiency.

Briefly summarized, in the transmitter of the present invention, a power detector and an interpolation unit are used to determine a specific predistortion parameter, and the specific predistortion parameter is used to predistort the input signal to pre-compensate the non-linear effect of the power amplifier. In addition, a complex adjusting parameter for compensate the signal distortion of the back-end circuits is determined before the predistortion parameters stored in the memory are updated by a LMS algorithm. Then, the speed to generate the predistortion parameters will be faster, and the system efficiency is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmitter, comprising:
a parameter generating and storing unit, comprising:
a storage unit, for storing a plurality of predistortion parameters;
an address generating unit, coupled to the storage unit, for determining an address signal including a first portion and a second portion according to a power of an input signal, and retrieving a first predistortion parameter and a second predistortion parameter from the storage unit according to the first portion of the address signal; and
an interpolation unit, coupled to the address generating unit, for performing an interpolation operation upon the first and the second predistortion parameters according to the second portion of the address signal to generate a specific predistortion parameter;
a predistortion calculating unit, coupled to the parameter generating and storing unit, for predistorting the input signal to generate a predistorted input signal according to the specific predistortion parameter; and
a transmitting circuit, coupled to the predistortion calculating unit, for processing the predistorted input signal to generate an output signal.

2. The transmitter of claim 1, wherein the address generating unit comprises:
a power detector, for detecting the power of the input signal to generate a power value; and
a multiplier, coupled to the power detector, for multiplying the power value by a power-scaling factor to generate the address signal.

3. The transmitter of claim 2, wherein the power-scaling factor is proportional to a gain of a power amplifier included in the transmitting circuit.

4. A method for lowering signal distortion, comprising:
providing a storage unit to store a plurality of predistortion parameters;
determining an address signal including a first portion and a second portion according to a power of an input signal, and retrieving a first predistortion parameter and a second predistortion parameter from the storage unit according to the first portion of the address signal; and
performing an interpolation operation upon the first and the second predistortion parameters according to the second portion of the address signal to generate a specific predistortion parameter;
predistorting the input signal to generate a predistorted input signal according to the specific predistortion parameter; and
processing the predistorted input signal to generate an output signal.

5. The method of claim 4, wherein the step of determining the address signal comprises:
detecting the power of the input signal to generate a power value; and
multiplying the power value by a power-scaling factor to generate the address signal.

6. The method of claim 5, further comprising:
providing a transmitting circuit to process the predistorted input signal to generate the output signal, wherein the power-scaling factor is proportional to a gain of a power amplifier included in the transmitting circuit.

7. A transmitter, comprising:
a predistortion calculating unit, for predistorting an input signal to generate a predistorted input signal according to a specific predistortion parameter;
a transmitting circuit, coupled to the predistortion calculating unit, for processing the predistorted input signal to generate an output signal;
a receiving circuit, coupled to the transmitting circuit, for receiving the output signal to generate a received signal;
an adjusting unit, coupled to the receiving circuit, for adjusting the received signal to generate an adjusted signal, where the adjusted signal is substantially equal to the input signal; and
a parameter generating and storing unit, coupled to the predistortion calculating unit and the adjusting unit, for generating the specific predistortion parameter, and updating at least one stored predistortion parameter according to the input signal and the adjusted signal.

8. The transmitter of claim 7, wherein the adjusting unit is a multiplier, and the parameter generating and storing unit further generates an adjusting parameter, and the adjusting unit multiplies the received signal by the adjusting parameter to generate the adjusted signal.

9. The transmitter of claim 8, wherein the parameter generating and storing unit utilizes a least mean square algorithm to determine the adjusting parameter.

10. The transmitter of claim 7, wherein the input signal is a down ramp signal, and the parameter generating and storing unit generates a plurality of predistortion parameters which correspond to a plurality of amplitudes of the input signal, respectively.

11. The transmitter of claim 7, wherein the parameter generating and storing unit utilizes a least mean square algorithm to update the at least one predistortion parameter, and a complex step size is utilized in a calculation of the at least one predistortion parameter.

12. A method for generating a plurality of predistortion parameters utilized for lowering signal distortion, comprising:
predistorting an input signal to generate a predistorted input signal according to a specific predistortion parameter;
processing the predistorted input signal to generate an output signal;
receiving the output signal to generate a received signal;
adjusting the received signal to generate an adjusted signal, where the adjusted signal is substantially equal to the input signal; and
updating at least one predistortion parameter stored in a storage unit according to the input signal and the adjusted signal.

13. The method of claim 12, wherein the step of adjusting the received signal to generate the adjusted signal comprises:
multiplying the received signal by the adjusting parameter to generate the adjusted signal.

14. The method of claim 13, wherein the adjusting parameter is determined by a least mean square algorithm.

15. The method of claim 12, wherein the input signal is a down ramp signal, and the step of updating the at least one predistortion parameter comprises:
generating a plurality of predistortion parameters which correspond to a plurality of amplitudes of the input signal, respectively.

16. The method of claim 12, wherein the at least one predistortion parameter is updated by a least mean square algorithm, and a complex step size is utilized in a calculation of the at least one predistortion parameter.
